(19) United States
(12) Patent Application Publication
(10) Pub. No.: US 2014/0068432 A1
(43) Pub. Date: Mar. 6, 2014

(54) ENABLING AUDIENCE INTERACTION WITH A BROADCAST MEDIA PROGRAM

(71) Applicants: Ezra Kucharz, Glen Rock, NJ (US); Adam Wiener, New York, NY (US); Christopher Oliviero, Brooklyn, NY (US); Adam Bloom, New York, NY (US); Serafin Michael Vazquez, JR., Cortlandt Manor, NY (US); Allan Bressler, Great Neck, NY (US); Andrew Dirnberger, Brooklyn, NY (US)

(72) Inventors: Ezra Kucharz, Glen Rock, NJ (US); Adam Wiener, New York, NY (US); Christopher Oliviero, Brooklyn, NY (US); Adam Bloom, New York, NY (US); Serafin Michael Vazquez, JR., Cortlandt Manor, NY (US); Allan Bressler, Great Neck, NY (US); Andrew Dirnberger, Brooklyn, NY (US)

(73) Assignee: CBS Radio, Inc.

(21) Appl. No.: 13/599,014

(22) Filed: Aug. 30, 2012

(51) Int. Cl. G06F 3/01

(52) U.S. Cl. 715/716

(57) ABSTRACT

The present application is directed towards systems and methods for providing audience interaction with a broadcast media program. A producer, utilizing an intuitive interface provided by a computing device can request audience input by providing polls or questions, which may be transmitted to a plurality of remote computing devices of the audience. An audience member may record a brief audio or video file, of up to a predetermined length, in response to a question via an application executed by their remote computing device. The application may transmit the recorded file to the computing device of the producer, who may review the recorded file and delete it, post it to a website, or download it for playback on air. Accordingly, the resulting system provides the ease, efficiency, and safety of asynchronous communication systems, while allowing audience members to hear their own comments and own voices on air.

### FIELD

The present application relates to systems and methods for enabling audience interaction with a broadcast media program via a network.

### BACKGROUND

Broadcast radio and television have provided countless hours of entertainment over the many decades of their use, although remote audience interaction has always been limited. Due to the one-way nature of broadcasting, providers were limited to asynchronous responses from the viewing or listening public, such as letters and postcards. As technology eventually progressed to email, and Facebook and Twitter posts, asynchronous audience interaction could become more immediate, but the textual messages were still either read by an on air persona or, in the case of television, could be displayed or scrolled across the screen. Though better, audience members might still feel not as fully engaged in a dialogue as they would like.

Telephones provided a means for synchronous communication whereby an audience member could call a studio phone line and be placed on air to engage in a dialogue with hosts and guests. Although this frequently added fascinating commentary and outside viewpoints—one of the reasons for the rise in popularity of political and sports talk radio—it has been inefficient. Telephone callers may not immediately launch into their question or comment, simply due to natural habits of, for example, greeting the host and thanking them for taking the call. Short comments or questions could result in a phone call of several minutes or longer.

Additionally, because telephone callers were live, there was the potential for profanity or other undesirable comments. Pre-screening telephone calls could not fully stop this problem, and while adding broadcast delays helped, it took away from the live immediacy of the show as well as creating potential echo loops when the telephone call included radio or television background noise (e.g., the same radio/television broadcast that the caller was calling into).

Accordingly, broadcasters were limited to inefficient solutions that let audience members directly state their comments on air, or asynchronous solutions that lacked real engagement or dialogue.

### SUMMARY

The present disclosure describes systems and methods for providing efficient and engaging audience participation, while affording a broadcaster easy editorial control. A producer of a broadcast program, utilizing an intuitive and simple interface provided by a computing device such as a tablet computer, can request audience input by providing polls or questions, which may be transmitted to remote computing devices of the audience or may be asked of the audience on air. An audience member may record a brief audio or video file, of up to a predetermined length, in response to a question, via an application executed by their remote computing device. The application may transmit the recorded file to the computing device of the producer, who may review the recorded file and delete it, post it to a website, or download it for playback on air. Accordingly, the resulting system provides the efficiency of using asynchronous communication systems, while allowing audience members to hear their own comments and voices on air.

### BRIEF DESCRIPTION OF THE FIGURES

FIG. 1 is a block diagram of an exemplary system for providing audience interaction with a broadcast media program;

FIG. 2A is a flow chart of an exemplary method for providing audience questions and receiving audience media files;

FIG. 2B is a flow chart of an exemplary method for receiving an audience question and providing an audience media file;

FIGS. 3A-3F are screenshots of embodiments of a client application for receiving information about a broadcast and providing audience interaction;

FIGS. 4A-4G are screenshots of embodiments of a producer application for providing information about a broadcast and requesting and processing audience interaction; and

FIG. 5 is a block diagram of an exemplary computing device useful for practicing the methods and systems described herein.

In the drawings, like reference numbers generally indicate identical, functionally similar, and/or structurally similar elements.

### DETAILED DESCRIPTION

The following description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

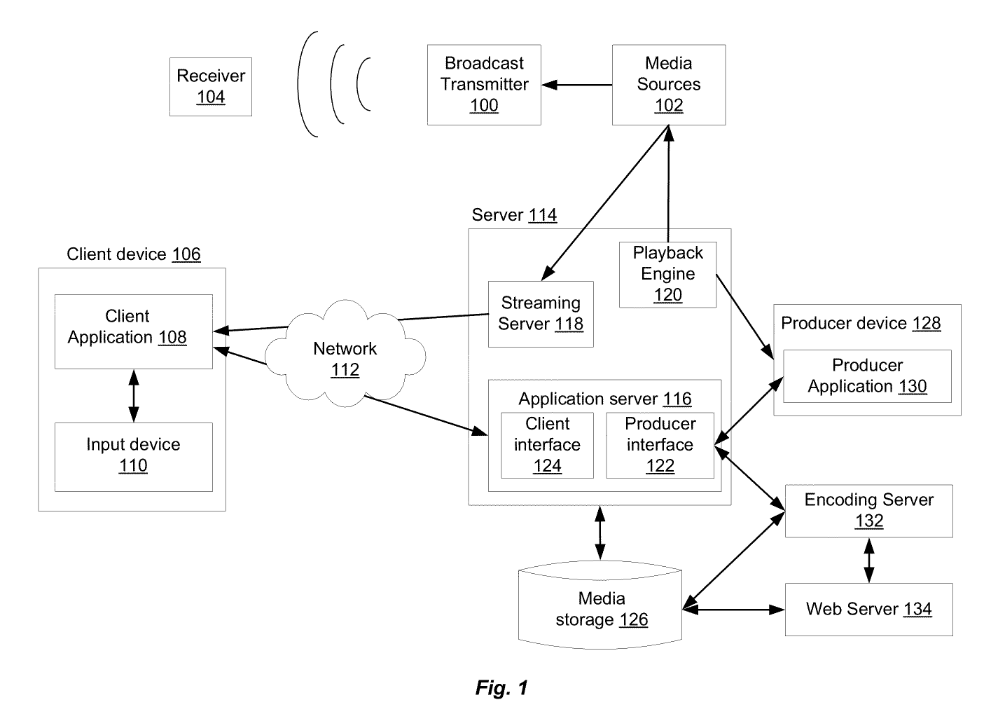

FIG. 1 illustrates a block diagram of an exemplary system for providing audience interaction with a broadcast media program. A media program, such as a television or radio program provided by media sources 102, such as microphones, cameras, audio and video playback devices, automation systems, or other broadcast sources, may be transmitted via a transmitter 100 to one or more receivers 104. Broadcast transmitters may comprise terrestrial or satellite transmitters of analog or digital radio or television, and accordingly, receivers 104 may comprise radios, televisions, satellite receivers, car stereos, or any other type and form of device.

Listening or viewing audience members may receive the program via a receiver 104, or via software executed by a client computing device 106, such as a smart phone, tablet computer, laptop computer, desktop computer, or any other type and form of computing device. For example, the broadcast program may be streamed via a network 112, such as a wide area network (WAN) such as the Internet, a local area network (LAN), a wireless network, a cellular network, or any other type and form or combination of networks to a recipient application 108 executed by the client device 106. Thus, the client application 108 may comprise a web browser, a dedicated application, service, widget, application, module, routine, or other executable logic or software for receiving streamed or multicast media.

A client application 108 may also enable a user to provide interactive responses to questions from the broadcast program provider or producer. For example, a broadcast producer may provide an audience question or poll. A poll may comprise a question and a number of predetermined answers, such as a true or false poll or a predetermined list of responses to a poll question. Conversely, an audience question may be an open-ended question or a question without selectable answers. A user of client application 108 may record their answer to an audience question in a media file, such as an audio or video file, via an input device 110, such as a microphone and/or camera of client device 106, or merely generate a text file (e.g., text string) via the input device 110, such as a keyboard. The client application 108 may transmit the recorded media file to a server 114 for review and playback by a producer. The media file may be broadcast, streamed on-line, posted on-line, or otherwise transmitted or made available.

A server 114 may comprise one or more computing devices, such as a cluster of servers, a distributed cluster of servers, a rackmount or desktop server, a server or servers provided by a cloud service, one or more computing devices executing one or more virtual machines, or any other type of computing device. A server 114 may execute one or more of an application server 116, a streaming server 118, and/or a playback engine 120, and may maintain or communicate with a media storage device 126. Although shown as a single server 114, various functions of server 114 may be provided by different computing devices.

An application server 116 may comprise an application, service, server, module, daemon, routine, or other executable logic for providing data to and receiving data from client devices 106 and producer devices 128. An application server 116 may comprise a web server, a database server, or an interface to a database. Data may comprise show information and/or station information, including guest and topic lineups or schedules; audience questions and polls; media files including images, text, videos, and audio files; or any other type and form of data. Data may be stored on a media storage device 126, such as a hard drive, array of drives, network storage device, or other storage device.

An application server 116 may provide a producer interface 122 and/or a client interface 124. A producer interface 122 may comprise a web application, web page, application interface, portal, or other interface for allowing a producer to provide show or station information, schedules, guest or topic lineups, questions or polls, and review audience answers. A producer may utilize a producer computing device 128, such as a tablet computer (e.g., an Apple iPad tablet computer or an Android OS-based Samsung Galaxy Tab computer); a desktop computer; a laptop computer; a smart phone; or any other type and form of computing device. The producer device 128 may execute a producer application 130, an example of which is discussed in more detail below, which may comprise an application, applet or smart phone app, widget, web application, web browser, module, or other executable logic for providing information, questions, and polls to a producer interface 122, and previewing and processing audience responses and media files. Similarly, a client interface 124 may comprise a web application, web page, application interface, portal, or other interface for allowing an audience member or user of a client device 106 to view show or station information, schedules, guest or topic lineups, questions or polls, and submit audience answers. A client interface 124 may push or transmit show information and questions to client device 106, or client devices 106 may pull or request show information and questions via the client interface 124.

Server 114 may comprise a streaming server 118, which may comprise an application, service, server, daemon, routine, or other executable logic for providing one or more streaming audio and/or video streams to client computing devices. Streams may be unicast or multicast. For example, a live audio stream may be multicast via User Datagram Protocol (UDP) or a similar protocol to a number of client devices 106. Thus, as used herein, a “broadcast” may refer to programming transmitted via terrestrial radio or television, cable television or audio distribution, satellite television or radio, and/or audio or video streamed via a network to an audience, individually or in groups. Such broadcasts can be a one way transmission from one or more sources to multiple listeners/viewers. Alternatively, such broadcasts can include some form of a bi-directional transmission between the source and listeners/viewers.

Server 114 may comprise a playback engine 120, which may comprise an audio and/or video interface for playing or previewing recorded media files. Such media files may be in the Moving Picture Experts Group (MPEG)-1, Layer 3 (MP3) or MPEG-4 Advanced Audio Coding (AAC) audio formats. For example, a playback engine 120 may comprise an audio output connected to a speaker or headphones for a producer to preview recorded media files provided by the audience. Similarly, a playback engine 120 may comprise an audio output connected to an audio mixing console or input of a digital audio workstation for playback on air. Playback engine 120 may comprise hardware, software embodied on a tangible medium, or a combination of hardware and software, and may perform processing or decoding of media files for playback or preview. Media files may be provided digitally to a workstation or other broadcast equipment and/or producer device 128, and accordingly, may be played back by these devices. In addition these media files could be video files (e.g., MPEG-4, H.264, etc.) where either the audio track is stripped out for use in an audio broadcast or alternatively the video files could be used in a television/web-based video program.

In addition to or instead of being broadcast, media files may also be uploaded or transmitted to a web server 134. For example, a producer may decide that a media file received by a user is interesting, but off-topic, or there may not be enough time in the show segment to play multiple media files from different users. Accordingly, the producer may direct server 114 to provide the media files to a web server 134 for presentation on a web site and viewing, listening, and/or downloading by users. Web server 134 may comprise a separate computing device or server as shown, or may be a server, service, or application executed by a server 114. Web server 134 may communicate with media storage 126, and/or may include media storage for storing media files for a web site.

To provide media files on the web site in formats playable on various computing devices, web server 134 and/or server 114 may include or communicate with an encoding server 132. An encoding server 132 may comprise a separate computing device as shown, or may be part of web server 134 or server 114. Encoding server 132 may comprise an application, server, service, or other executable logic for encoding or transcoding media files from a received format to one or more other formats. For example, a client device 106 may be an Apple iPhone, and may record an audio file in a Waveform Audio File (WAV) format, or client device 106 may be an Android-based smart phone and may record an audio file in an MPEG-1, Layer 3 (MP3) format. To ensure that either device, or any other desktop, laptop, tablet, or other mobile computing device may be able to play the media file provided to the web server 134, encoding server 132 may transcode the WAV file to an MP3 format, and/or any other type and form of file format, or vice versa. Transcoding may include resampling, compression, and/or decompression. Encoding server 132 may also perform additional processing on audio and/or video of the media file, including normalizing, filtering, rescaling, rotating, color conversion, and/or performing audio compression, gating, or expansion, noise reduction, or any other such processing steps. Transcoded media files may be stored in media storage 126 and/or provided to web server 134 in one format or multiple formats, allowing each device to download and play media files in a preferred format.

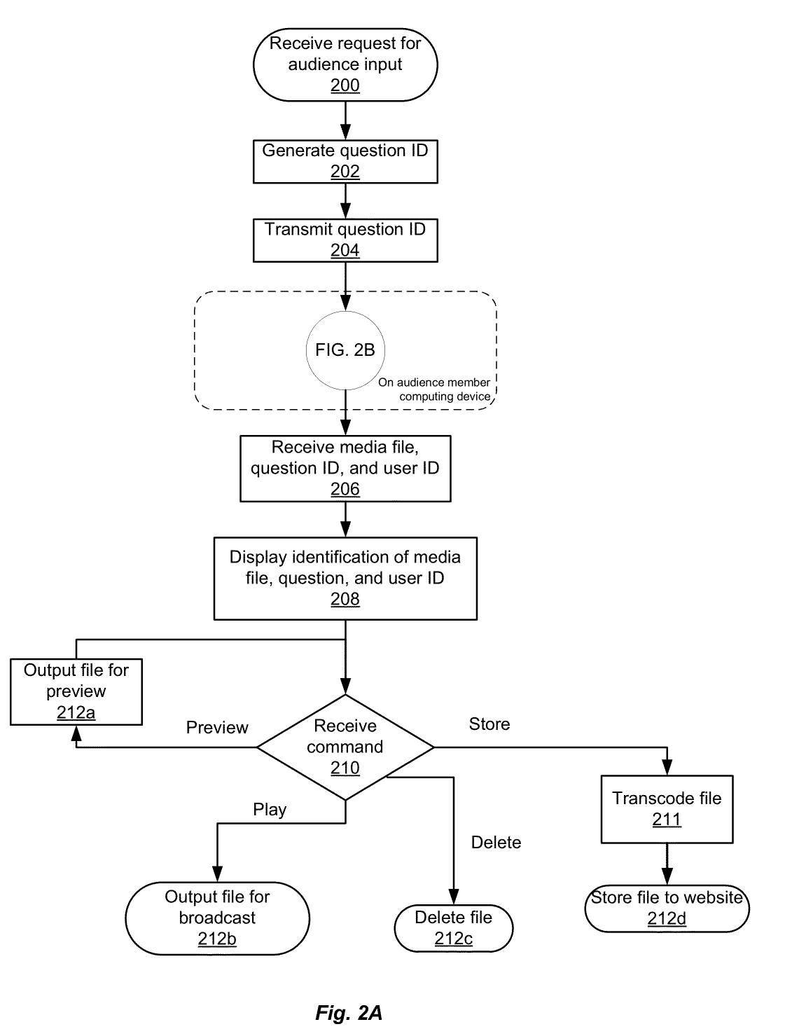

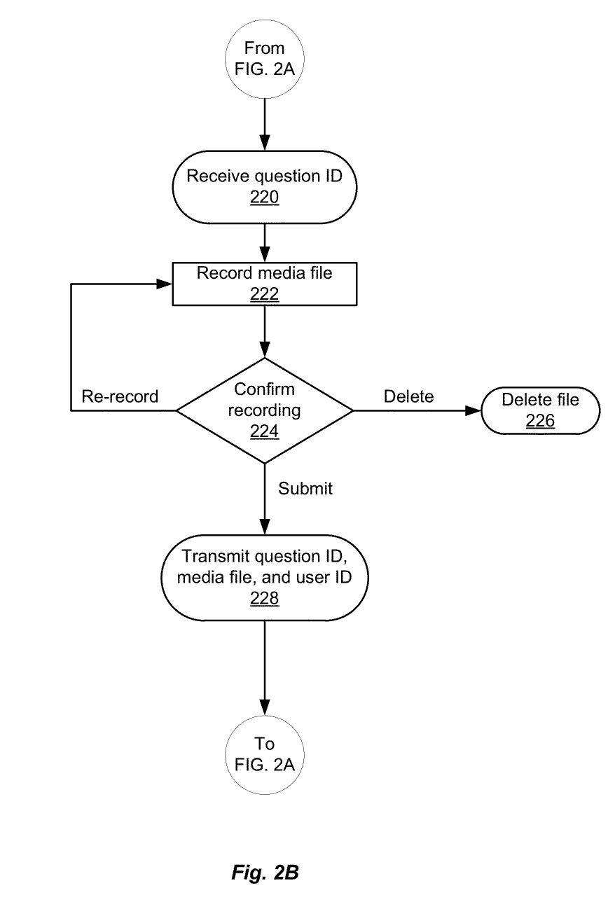

The flow chart of FIG. 2A illustrates a method for providing audience questions and receiving audience media files. At step 200, a computing device may receive, from a producer of a broadcast media program, a request for audience input, the request comprising an audience question. The producer may send the request for audience input to the computing device from a producer device or application executed by a producer device. The audience question may be a text question, a video question, an audio question, or a question in any other format. The producer may send the audience question with the request, or the producer may enter one or more audience questions prior to the broadcast program, and request a question to go “live” or be transmitted to audience computing devices. The producer may enter a broadcast time of a planned topic corresponding to the audience question, and the computing device may identify the request as live or current, responsive to a current time reaching the entered broadcast time. A question may be posed to the audience via the broadcast medium. For example, the question may be asked on air by a host or guest, and the producer may send the request for audience input without including the question. The question may have multiple associated predetermined opposing viewpoints (e.g. “pro”, “con”, “democrat”, “republican”, “Yankees”, “Red Sox”), which may be entered or selected by the producer to ease in classification of answers.

At step 202, the computing device may generate a question ID for the audience question. A question ID may comprise a code, timestamp, index number, or other identifier to uniquely identify the question, or the question itself may comprise the identifier. For example, the question ID may comprise all or part of the question, such as a text question or audio or video file of the question. If the question has multiple associated predetermined viewpoints, the computing device may generate a viewpoint identifier for each viewpoint.

At step 204, the computing device may transmit the question ID to one or more remote computing devices of audience members. Alternately, the remote computing devices of audience members may request the question, either periodically or responsive to an audience member input or selection, and the computing device may transmit the question ID responsive to the request. For example, the audience member input or selection may include preferences set in the audience member's remote computing device, such as a time period for periodically requesting questions, or may include specific actions the audience member has performed on the audience member's remote computing device such as selecting a question screen, pressing a “request new question” button, or any other input. The computing device may transmit the audience question for display on the audience member's computing device. If the question has a number of associated predetermined viewpoints, the computing device may transmit the viewpoint identifiers for display along with the question, for selection via a pull down menu, radio button, checkbox, or similar user interface element. Alternatively, the computing device may transmit only certain questions and/or viewpoint identifiers based on the audience member's pre-designated preferences, behavioral characteristics and/or user profile.

Referring now ahead to FIG. 2B, a method for receiving an audience question and providing an audience media file is illustrated. The method of FIG. 2B may be considered a companion to the method illustrated in FIG. 2A, describing steps that occur on a computing device of an audience member. At step 220, a computing device of a user may receive, from a remote computing device, a question ID generated responsive to a request of a producer of a broadcast media program for audience input. As discussed above, the computing device may receive the question ID responsive to transmitting a request to the remote computing device for the question ID. The user may select to record a media file by selecting a button in an application executed by the computing device, and responsive to the user selection, the application may transmit a request to the remote computing device for the question ID. The computing device may also receive an audience question, comprising an audio file, video file, and/or text string that a producer has entered to solicit an answer, or the user may hear or view the question during the broadcast, and may respond accordingly. The computing device may further receive, from the remote computing device, an identifier of a number of predetermined opposing viewpoints associated with the question, as discussed above.

At step 222, the user or audience member may record a media file. Recording a media file may comprise recording a media file of up to a predetermined length. The media file may be recorded with an input device of the computing device of the user, such as a camera and/or microphone. The media file may be recorded as a Motion Picture Experts Group (MPEG)-1 or -2 Audio Layer 3 (MP3) file, a Waveform Audio File Format (WAV) file, an Advanced Audio Coding (AAC) audio file, an MPEG-4 video file, a MPEG-2 video file, a Windows Media Video (WMV) or Windows Media Audio (WMA) file, an ITU-TH.264/ISO/IEC MPEG-4 AVC file, or any other type and form of media file as discussed above. The user may select a viewpoint for the media file from a list of predefined opposing viewpoints associated with the question, as discussed above, such as via a radio button, checkbox, menu item, or any other type and form of software graphical selection.

At step 224, the user or audience member may review or confirm the recording. The user or audience member may play the recorded media file on the computing device for review and may select to discard the recorded file and re-record the media file at step 222. Alternately, the user may select to delete the file at step 226 and cancel recording.

The user may also select to submit the file for on air playback and/or upload to a website at step 228. The computing device may retrieve a saved user identifier for the user, such as a name, email, username, password, or other user identifier information as discussed above. The computing device may prompt the user for a user identifier, and provide a user interface element for entry of the user identifier information. Responsive to the selection, the computing device may transmit one or more of the recorded media file, the question ID, a viewpoint identifier, and the user identifier to the remote computing device for review by a producer.

Returning to FIG. 2A, at step 206, the computing device of the producer may receive, from a remote computing device of an audience member, a media file recorded by the audience member. The media file may comprise any type or form of media file, such as an MP3 audio file, a WAV file, an AAC file, an MPEG-4 video file, an H.264 video file, or any other type and form of media file. The media file may be unlimited in length or limited to a predetermined length. For example, the audience member may be limited to recording 5 seconds, 10 seconds, or any other predetermined length of media file. The computing device may receive the question ID from the audience member, and may associate the media file with the question ID. Alternately, the computing device may receive the media file and identify the media file with the question ID, responsive to the question ID or audience question being a “live” question or current question posed to the audience. The computing device may alternately receive the media file with a recording timestamp, and may identify the media file with the question ID, responsive to the question ID or audience question being an active question posed to the audience at that timestamp. The computing device may also receive a user identifier with the media file. A user identifier may comprise a name, an email address, a gender, an age or birth date, an account or user name, a password, a device identifier, and/or other such identifier. The computing device may annotate the media file with the received user identifier via metatags incorporated into the file; an entry in a database identifying the question, user, media file; or any other method. If the question has multiple associated viewpoints, the computing device may receive, from the remote computing device, the identifier of one of the viewpoints selected by the user. For example, a user may record a media file explaining support for a ballot question and may select an identifier of “yes” or “pro”, which may be transmitted along with the media file for ease of review by a producer.

At step 208, the computing device may display, to the producer, the audience question, an identifier of the received media file, and/or the corresponding user identifier. Displaying the identifier of the received media file may comprise transmitting an identifier of the received media file to a producer computing device, such as a tablet computer, or to an application or web browser executed by a producer computing device. The computing device may transmit a web page, extensible markup language (XML) file, data file, list, database query result, or other data comprising identifiers of one or more received media files associated with an audience question and/or question ID, and corresponding user identifiers. The computing device may transmit an identifier of a viewpoint of a number of predetermined viewpoints selected by the user and associated with each media file. The computing device may maintain a database of users that are associated with media files previously transmitted to the computing device, and may identify repeat users. The computing device may further identify whether the repeat users have sent media files that were used on air, uploaded to a website, or deleted, or a percentage of media files that were retained versus deleted. Such data can help a producer to quickly categorize and prioritize received files.

At step 210, the computing device may receive a command from the producer, such as a command to preview a media file; a command to download a media file to a workstation, media playback system or digital cart system, or a computing device of the producer; a command to upload a media file to a website for later retrieval, listening, or viewing by visitors; or a command to delete the media file. The computing device may receive the command via a Hypertext Transfer Protocol (HTTP) GET or POST request, an application programming interface (API) command, a database or other query, or other such methods.

The received command may be a preview command, and at step 212a, the computing device may output or playback the file for preview. The file may be transmitted to a producer computing device for playback via an audio or visual display interface of the producer computing device, and/or the file may be played via an audio or video output of the computing device, such as via speakers, headphones, or a video monitor. The computing device may receive a command to queue and playback in succession multiple media files for preview. This approach allows a producer to quickly listen to a large number of files and select which files are most appropriate for on air playback.

The received command may be a playback or download command, and at step 212b, the computing device may transfer, output or play the file for on air broadcast. The computing device may transfer the file to a workstation, media playback system or digital cart system to be queued for on air playback, and/or the computing device may play the media file via an analog or digital output to a mixer or switcher for playback on air, or via other broadcast equipment. The computing device may indicate, in a database entry corresponding to the user identifier associated with the media file, that the media file has been selected for on air playback, or may increment a played media file counter. This approach may aid a producer in selecting files in the future based on a positive record of the user.

The received command may be a delete command, and at step 212c, the computing device may delete the media file. The computing device may indicate, in a database entry corresponding to the user identifier associated with the media file, that the media file has been deleted, or may increment a deleted media file counter. The indication or counter value may aid a producer in selecting files in the future based on a negative record of the user.

The received command may be a store or push to website command, and at step 211, the media file may be transcoded to one or more formats, as discussed above, to allow playback by different devices in native and/or preferred formats. For example, an MP3 audio file may be transcoded into a WAV file format and/or an AAC file format, or an MPEG-4 video file may be transcoded into an H.264 video file format. At step 212d, the computing device may upload the file and/or transcoded version or versions of the file to a web site or web server. For example, the producer may determine that a file is appropriate for audience or website visitor consumption, but not timely enough, clear enough, insightful enough, or otherwise suitable for on air playback. The producer may opt to retain the file in a searchable database online, or post the file to a commentary page associated with the show or topic for visitors to view or listen to. The computing device may indicate, in a database entry corresponding to the user identifier associated with the media file, that the media file has been uploaded to a website, or may increment an uploaded media file counter. This approach may aid a producer in selecting files in the future based on a positive record of the user.

Accordingly, through the methods and systems described above, a user may provide audio and/or video recordings of up to a predetermined length in response to prompted questions from a producer of a broadcast media program for playback on air. The recordings may be reviewed for obscenity or profanity, relevance and insight, clarity, humor, or other features, and may be selected by the producer for on air playback, upload to a website, or deletion. Audience members can feel more engaged in the program, without requiring live telephone calls, which may interfere with the pace of the show.

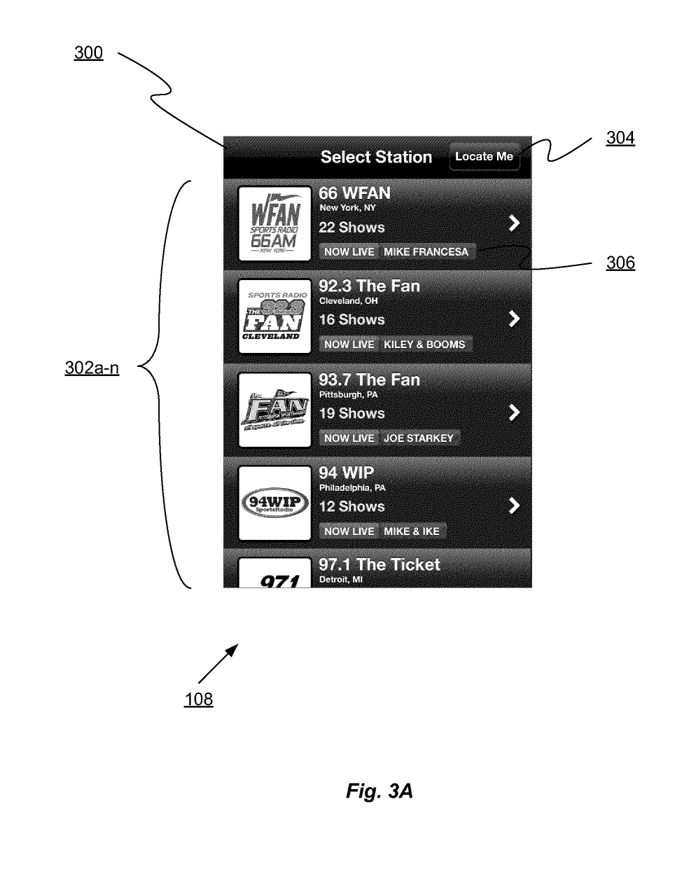

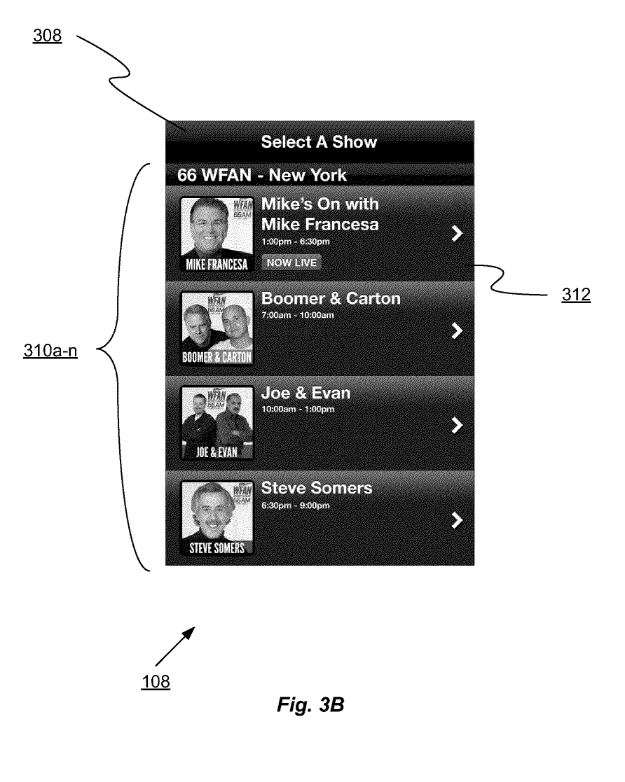

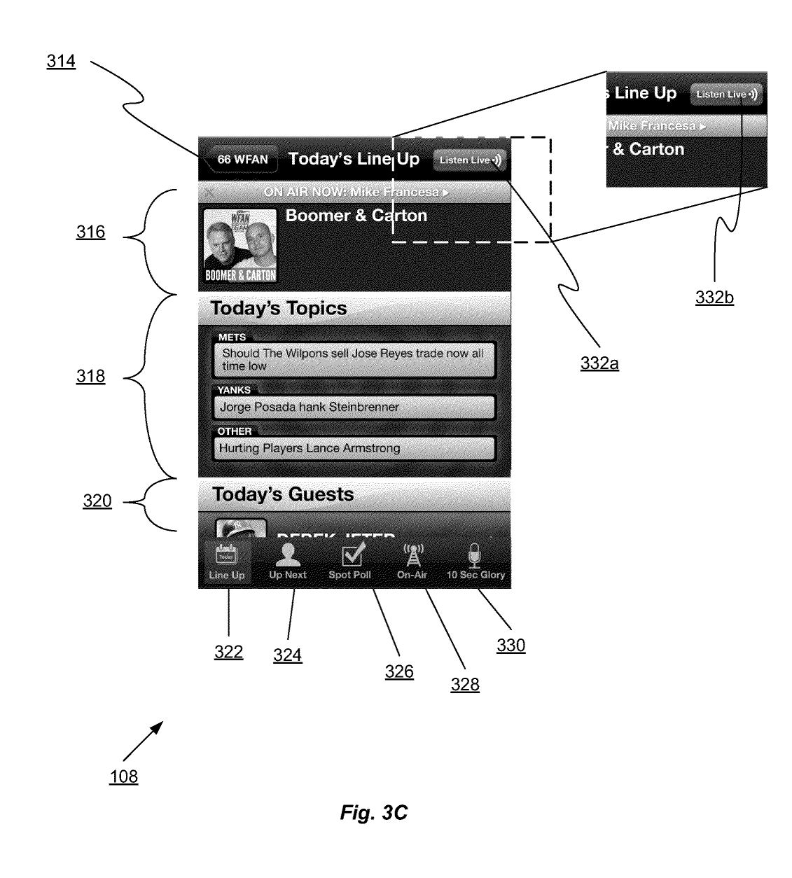

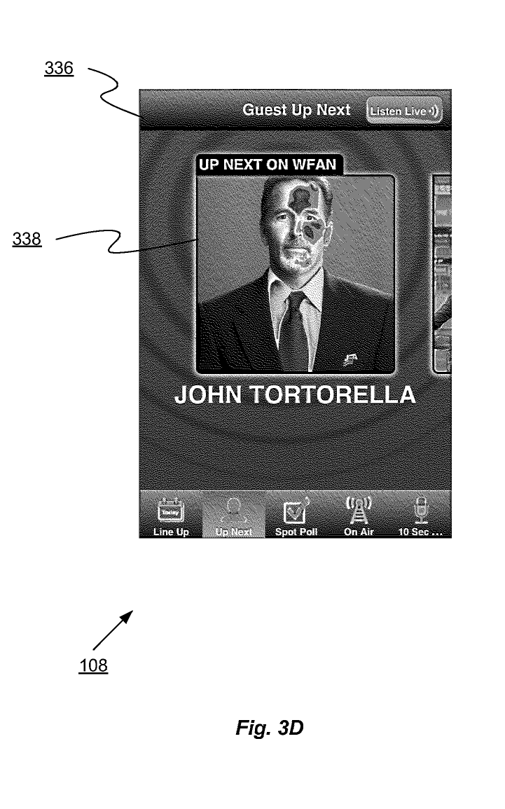

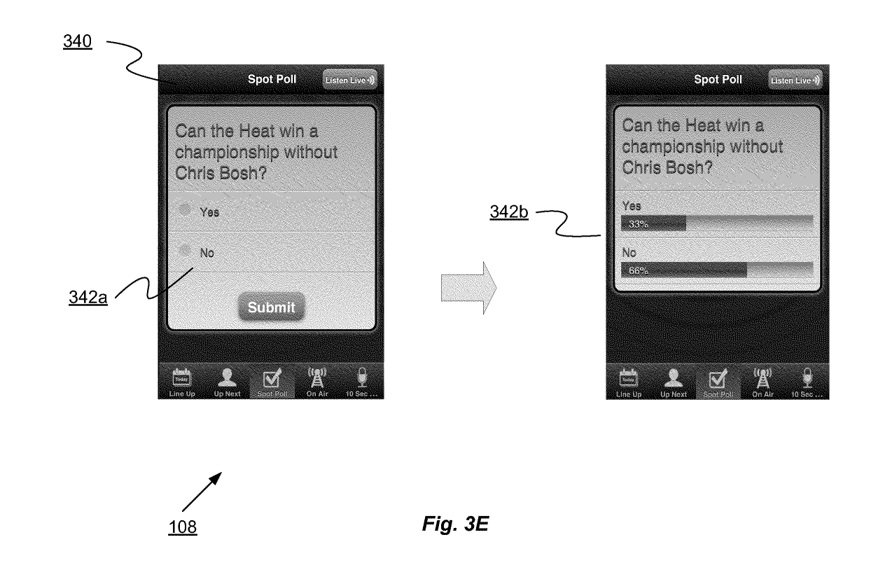

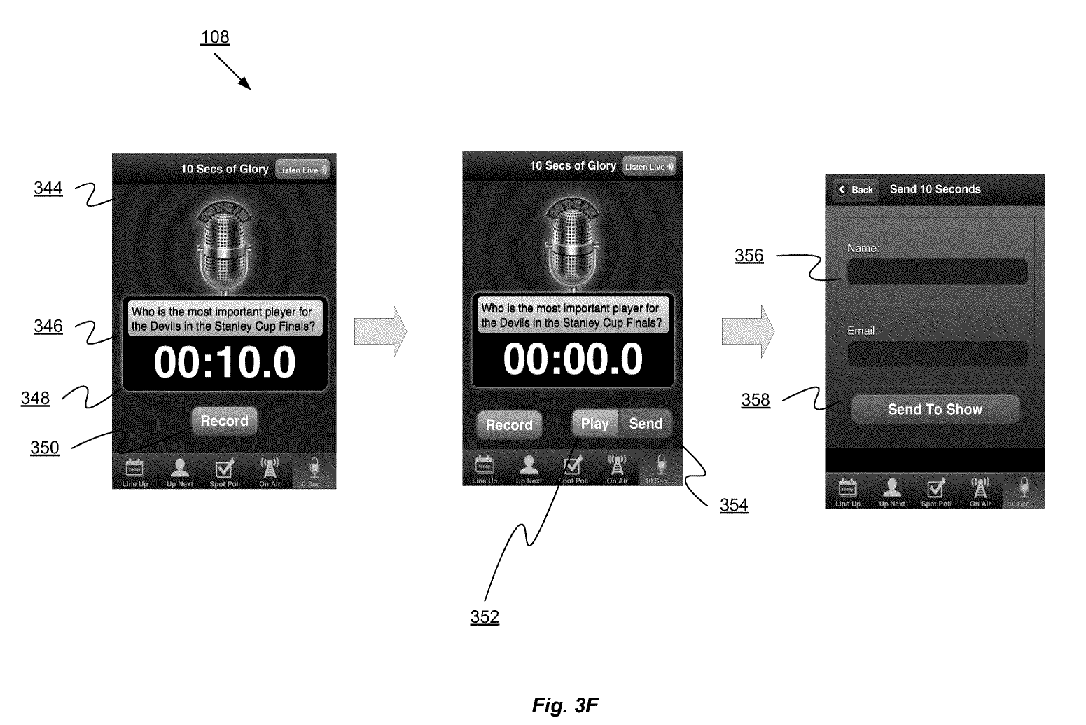

FIGS. 3A-3F illustrate screenshots of a client application 108 for receiving information about a broadcast and providing audience interaction. The screenshots are provided for exemplary purposes only, and one of skill in the art may readily envision variations that do not depart from the scope of the systems and methods discussed herein. The client application 108 may be a dedicated application or app, such as a smart phone app, or the client application 108 may comprise a web application.

Referring first to FIG. 3A, a screenshot of a client application 108 that provides a station selection screen 300 is shown. The client application 108 may be provided to audience members in multiple markets, or listeners of multiple stations, including satellite radio and television stations, terrestrial radio and television stations, cable radio and television stations, and Internet radio and television stations. The station selection screen 300 may be used by the user to select a station to “tune” into with the application 108, both for listening or watching the streamed broadcast program via a network connection, and for receiving proper show information and audience questions. A user may select a “locate me” button 304, and responsive to the selection, the application 108 may utilize location services, such as Global Positioning System (GPS), WiFi (IEEE 802.11 standards family) or cellular location to geographically locate the user. Responsive to determining a position of the user, the application 108 may transmit a query to a remote computing device or server to retrieve a list of stations 302a-302n that the user may be able to receive, based on their geographic location and/or market. The application 108 may alternately display a list of stations 302a-302n that are available for streaming via the network. Each identifier of a station may include a logo, title, location, frequency or channel, and an identifier of a current live show 306.

Referring now to FIG. 3B, a client application 108 may provide a show selection screen 308. Once a user has selected a station via screen 300, the user may be presented with a show selection screen 308 illustrating a schedule of all of the shows 310a-310n on the station schedule. Each entry for a show may include a picture, a title, a time, a topic, a guest identifier, or an indication 312 that the show is currently live or on air.

FIG. 3C shows an example of a client application 108 providing a line up display 314. A line up may comprise an identifier of the show 316, including a picture and/or title; an identifier of one or more topics 318; or an identifier of one or more guests 320 scheduled to appear on the particular show. The line up display 314 may be dynamically updated during the show, or display only present and/or upcoming guests and topics. For example, if a first guest is scheduled to be on air from 9:00 AM to 9:30 AM, the list of guests 320 may be updated after 9:30 AM to remove the identifier of the first guest. Accordingly, a user may see at a glance both what is on air and what will be coming up. Past topics and guests for the show may also be displayed.

A client application 108 may include a navigation bar or one or more software graphic buttons 322-330 for switching between screens, such as a line up screen button 322, an up next screen button 324, a spot poll screen button 326, an on air screen button 328, and an audience question and answer recording screen 330. The client application 108 may further include a button to start listening or watching an audio and/or video stream of the show 332a. If the user selects button 332a, the button may change to a stop button 332b, as shown in the inset.

FIG. 3D illustrates a screenshot of an example of a client application 108 providing an up next screen 336. An up next screen 336 may display an identifier 338 of one or more guests and/or topics scheduled for later in the show. The display of guests and/or topics may be scrollable by the user, and the user may select an identifier of a guest and/or topic for more information, such as a biography of a guest or a news article relevant to the topic. The application 108 may display an identifier of previous appearances of the guest, as well as a historical rating of the guest's appearances on the show. For example, as discussed in detail below, an application 108 may enable audience members to rate a guest positively or negatively, or on a scale, and transmit the rating to a server for aggregation. Accordingly, audience members may vote on whether they like a guest or identify with the guest's point of view, and guests may be rated (and potentially re-scheduled) on the basis of the audience members' collective votes. Similarly, a client application 108 may display an on air screen, which may identify a guest currently on air or a topic currently under discussion. Multiple guests can appear in an on air screen, such as when a roundtable discussion is scheduled.

FIG. 3E illustrates screenshots of a client application 108 providing an audience poll screen 340 with a question 342a and result 342b. A producer may provide a poll and one or more answers to a server, which may transmit the poll to client applications 108 of audience members' computing devices. Poll questions may be updated or replaced during the show according to a predetermined schedule, or dynamically or manually by a producer. Audience members may provide a poll choice that may be instantly aggregated with other members' choices, and the server may transmit results 342b for display on client applications 108 and/or on a producer display. As discussed above, a similar rating system may be used to rate guests and/or topics, via yes/no buttons, good/bad buttons, a rating scale, a sliding scale, a dial, or any other such interface. Rating results may be displayed as shown in a graph, or as a hot or cold rating on a stylized thermometer, a soft or loud rating on a stylized VU meter, or any other such graphical designs.

The rating system may further provide functionality for an interactive debate format. For example, the broadcast program may include debaters with different positions on a topic. Audience members may utilize poll choices to indicate agreement or approval, or disagreement or disapproval with a debater's position or argument. A tally of votes, by number, percentage, or any other indicator, may be displayed, allowing audience members to contribute and interact with the debate. Similar systems may be used for providing audience participation and feedback during election debates, panel discussions, or any other type and form of discussion between multiple participants that is viewed or listened to by an audience. FIG. 3F illustrates screenshots of a client application 108 providing an audience question and answer recording screen 344. The client application 108 may display a question 346 entered by a producer and transmitted by a server to the audience member's computing device. The question may be textual, as shown, or the question may be an audio and/or video question, and may be played back manually by the user. The question may also or instead be asked on air or via the broadcast. A timer 348 may be shown, set to a predetermined maximum time duration for a recorded media file, such as 10 seconds. The user may select a record button 350, and, the timer 348 may begin counting down while the user records their audio and/or video answer to the question 346. Once recorded, as shown in the middle screenshot, the user may select buttons to re-record the media file; play or review 352 the media file; and/or send or submit 354 the media file to the producer. Alternately, the user may be allowed to record any duration of media file. Responsive to the user selecting to submit the media file, the user may be asked to provide user information, such as a name and/or an email address 356, as discussed above. Stored user information may be retrieved, and optionally displayed for user verification. The user may select a button 358 to confirm submitting the media file to the show.

To further incentivize user participation, the system may provide awards or other features. For example, the system may provide badges, points, or other indicators responsive to a user recording and submitting a media file, voting on a poll option, rating a guest or debater, having a submitted media file be played on air or uploaded to a website, sharing a link to a show via a social network, reviewing the application, inviting a friend to join, or other interactions. User badges or points may be displayed on a website or within the application, such as via a scoreboard, allowing a user to see how he or she ranks against other users. Highly ranked users may be invited to participate in discussions or even join the broadcast show as a telephone or in-studio guest. For example, if a particular user provides a large number of media files that are played on air, a producer may recognize that the user is insightful or witty, and invite the user to participate in a more real-time format. When a user's media file is played on air, the application may display the user's name and points or badges, allowing other audience members to see the user's ranking and/or achievements.

As discussed above, votes on polls or regarding guests and/or topics may be tallied directly, or may be weighted. For example, a vote by an audience member with a high ranking may be weighted more heavily than a vote by a first-time voter or new audience member. This may encourage users to utilize the application more often so that they have increased influence on polls, guests, and topics. Votes may be weighted responsive to user rank, badges, and/or achievements; number of previous votes; account activity; time since the account was started or the user downloaded the application; number of media files sent in, played on air, and/or uploaded to a website; or any other statistics. Votes may also be weighted down, for example, responsive to a user submitting multiple media files that are deleted or discarded without being played on air. Such weightings may further aid in reducing Internet flash mob effects, in which a large number of people who would not otherwise be audience members are encouraged via social networking sites to install the application and vote for a certain option. Since the votes of such new users may be weighted lightly in comparison to the votes of long time users, the mob influence on the results will be diminished.

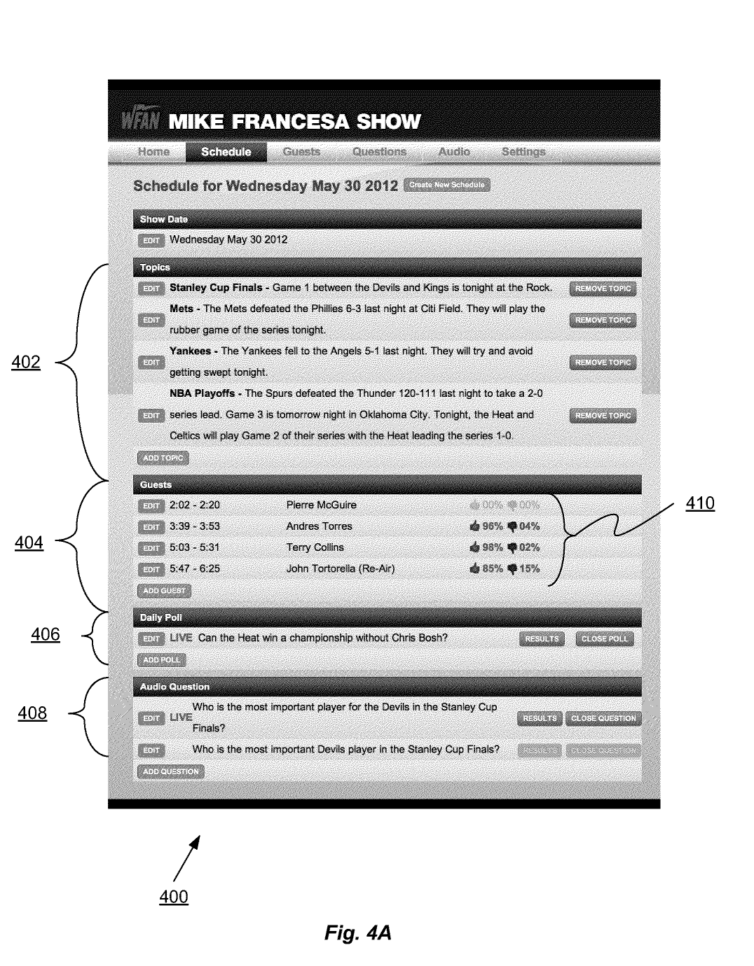

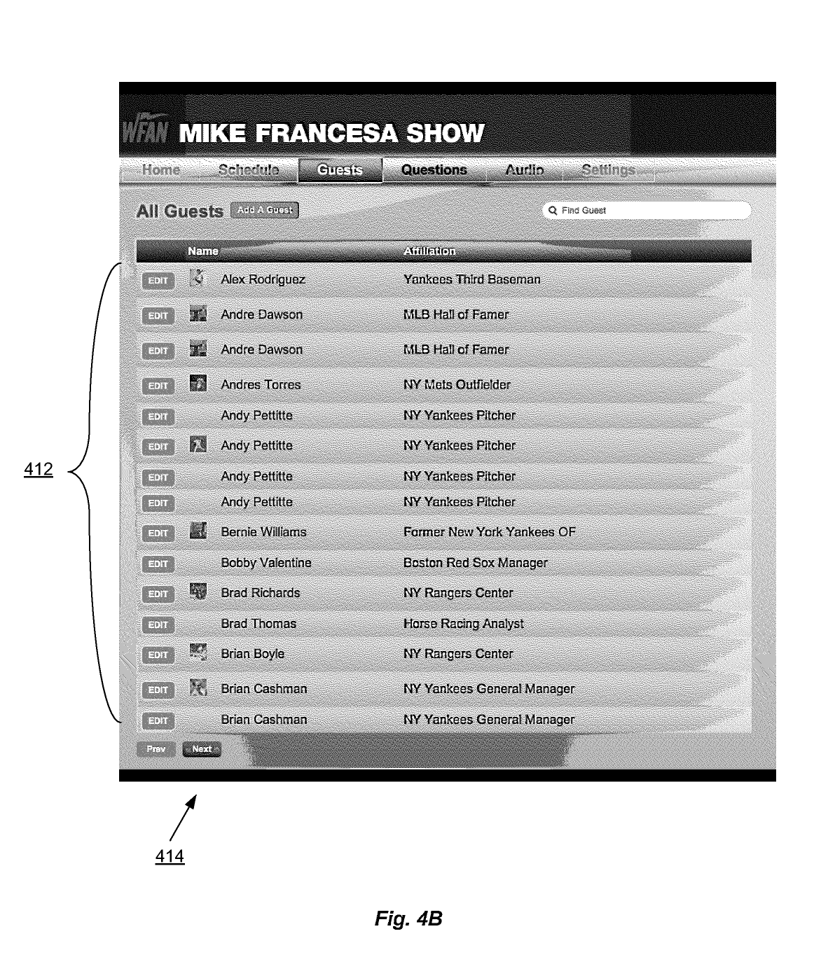

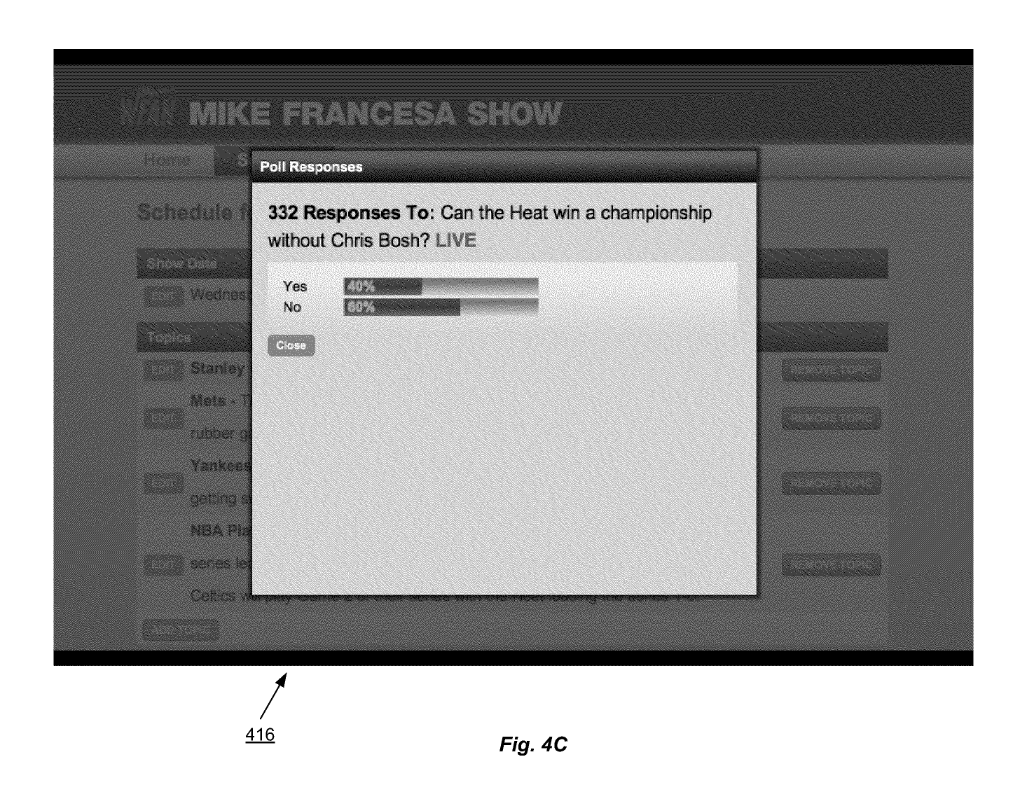

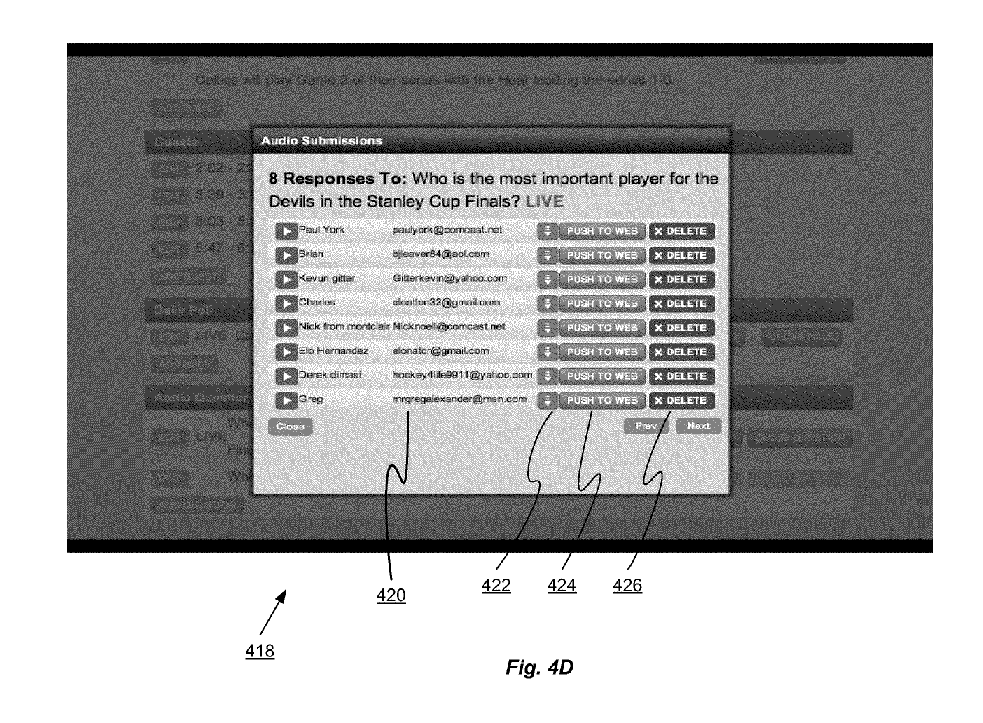

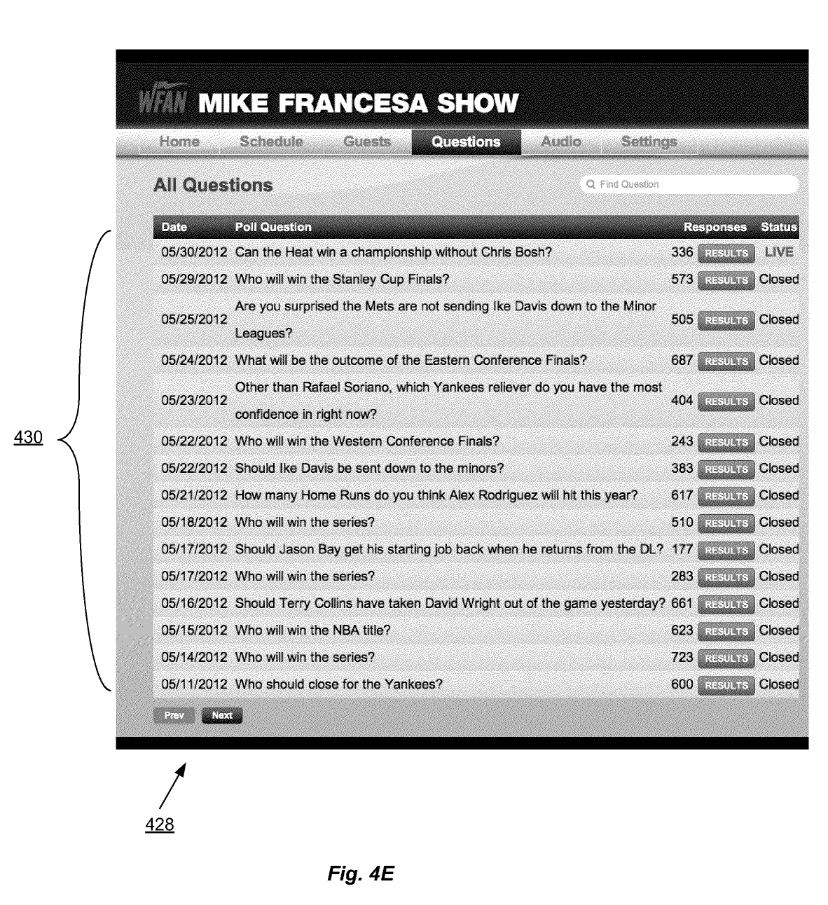

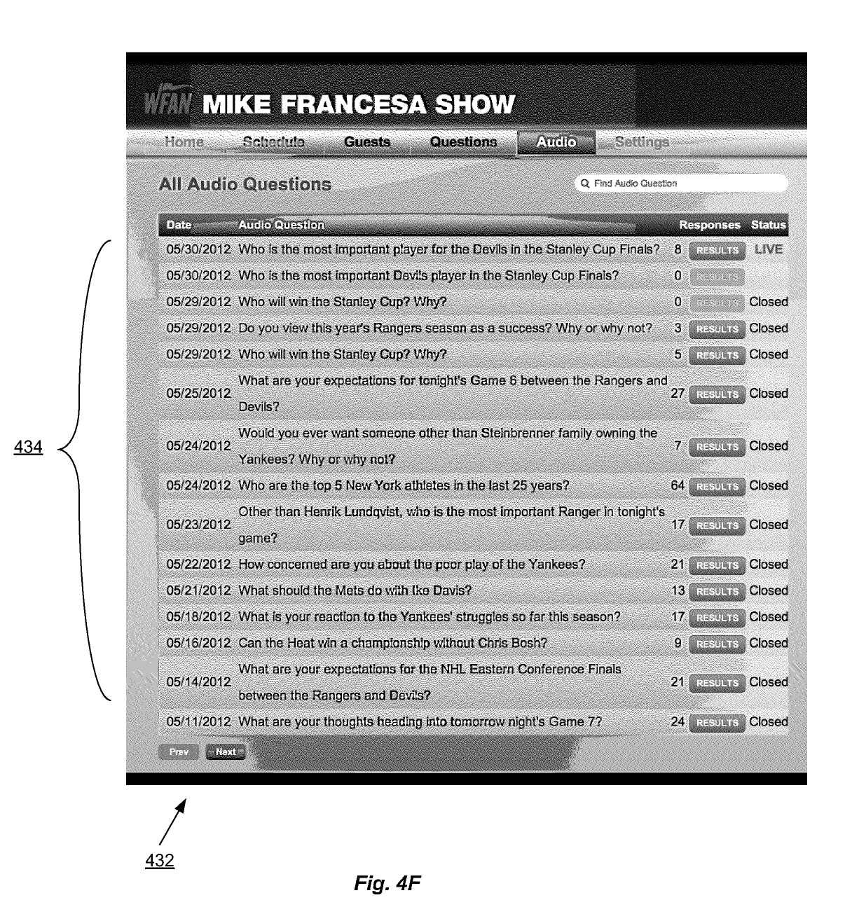

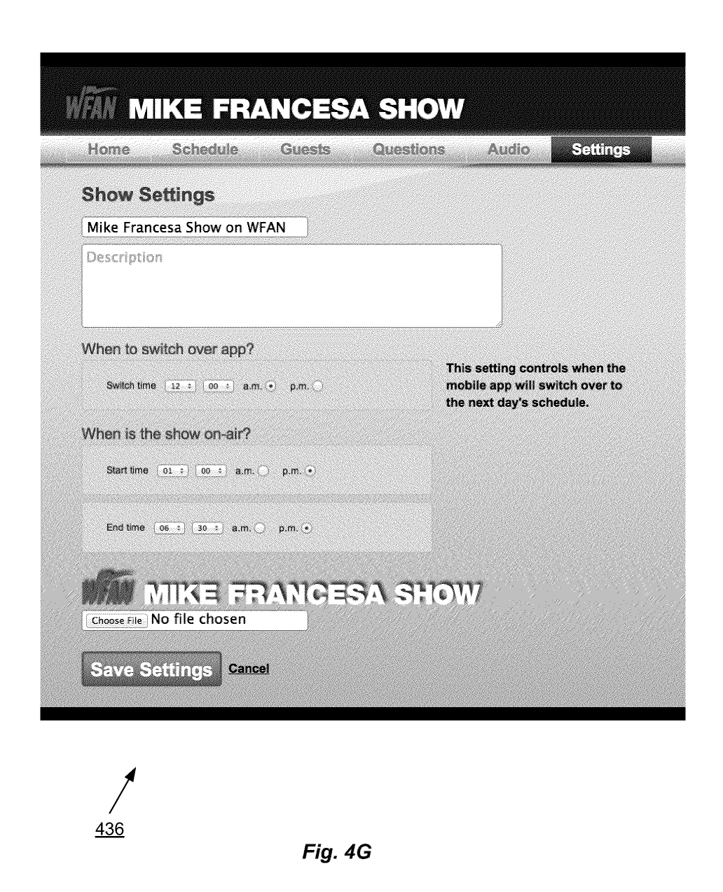

Referring now to FIGS. 4A-4G, illustrated are screenshots of a producer application 130 for providing information about a broadcast and requesting and processing audience interaction. The producer application 400 may be a dedicated application or applet, such as a smart phone or tablet software application, or may comprise a web application, such as an interactive Internet page delivered by a web server.

FIG. 4A shows a schedule screen 400 of a producer application 130. The schedule screen 400 may allow a producer to create a schedule for a show, including adding, removing, editing, or re-ordering one or more topics 402; adding and scheduling one or more guests 404; adding, editing, and closing one more polls 406; and adding, editing, and closing one or more audience questions 408. The schedule may be specific to a show and specific to a date, hour, or segment. A producer may add a number of topics, which may be transmitted to audience members' client applications for display.

The producer may add a number of guests 404 to appear during a show and may schedule each guest by time, as discussed above, such that “up next” and “on air” screens of a client application may be dynamically updated. The producer application 130 may display an audience rating 410 of each guest, based on polls or votes of audience members taken during previous visits of the guest to the show. As shown, guests may be rated as good or bad or thumbs-up versus thumbs-down, or may be rated by viewpoint (e.g. “liberal”, “moderate”, or “conservative”), allowing more creative scheduling of the show by the producer. Referring briefly ahead to FIG. 4B, a guest selection screen 414 is shown. Guests 412 may be added to the system by a producer and identified with a name, picture, affiliation, point of view, or other identifiers, including audience ratings 410 as discussed above. The producer may efficiently schedule a guest for a show who has previously been added to the system by searching the directory for the guest and selecting them for addition into the schedule 404.

As discussed above, identifiers of scheduled guests may be transmitted to computing devices of audience members. Utilizing the polling features discussed above, audience members may be able to vote or rank scheduled guests and/or topics to be discussed. Such votes may be provided to the producer, granting the producer additional insight into audience preferences and potentially allowing the producer to re-order guests or topics for discussion. As discussed above, points or badges may be rewarded to audience members in appreciation for their feedback improving the show. This may further incentivize audience members to listen or watch a show they helped create, or may encourage the members to contact friends to input additional votes on a topic and/or guest.

Returning to FIG. 4A, the producer may add and/or edit one or more audience polls 406. Polls may be listed in sequential order and may be scheduled to close at predetermined times, or may be manually closed by a producer, initiating a subsequent or next poll in the list 406. Referring briefly to FIG. 4C, a poll response review screen 416 may display the results of a poll for the producer. Two answers may be displayed (e.g. yes/no, true/false), or the poll may comprise multiple answers (e.g. a list of teams in a division).

Returning to FIG. 4A, the producer may add and/or edit one or more audience questions 408. As with polls 406, audience questions may be listed in sequential order and may be scheduled to close at predetermined times, or may be manually closed by a producer, initiating a subsequent or next question in the list 408. As with polls, the producer may review received responses or media files. For example, FIG. 4D shows a media file review screen 418 displaying media files received responsive to an audience question for review. Each media file may be displayed along with corresponding user information 420 such as name and/or email address or other information as discussed above. A play button may be provided to preview one or more media files. As discussed above, a producer may select a number of play buttons to queue up a number of media files for efficient, successive preview. The producer may select via a download button 422 to download the file to a digital cart system, workstation, automation system, or other computing device for on air playback; may select via a “push to web” button 424 or similar button to upload the file to a web server for incorporation in a comments page of the show or database of media files; or may select via a delete button 426 to delete the file.

FIG. 4E shows a historical poll review screen 428 allowing a producer to view a list 430 of all present and previously asked poll questions. This may be valuable for show research, revisiting periodic questions, or for avoiding re-asking identical questions. Similarly, FIG. 4F shows a historical audience question review screen 432 allowing a producer to view a list 434 of all present and previously asked audience questions and allow the producer to review results, as well as retrieving stored media files for on air playback as shown in FIG. 4D.

FIG. 4G shows a settings screen 436, through which a producer may edit details about a show, including description, daily schedule times, and show start and end times, as well as uploading or selecting logos or other images to be transmitted to client computing devices for display to audience members.

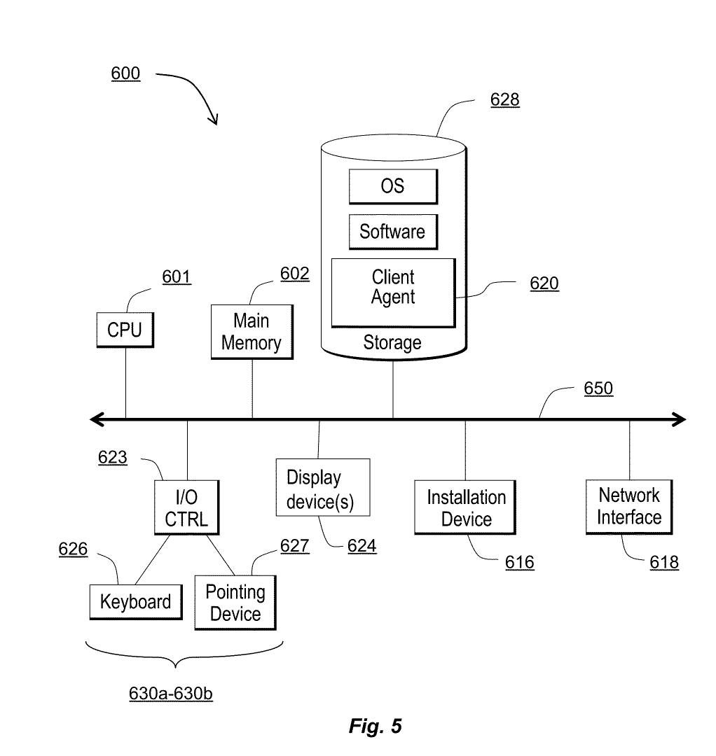

The client device 106, server 114, and producer device 128 may be deployed as and/or executed on any type and form of computing device, such as a computer, network device or appliance capable of communicating on any type and form of network and performing the operations described herein. The computing device may comprise a laptop computer, desktop computer, virtual machine executed by a physical computer, tablet computer, such as an iPad tablet manufactured by Apple Inc. or Android-based tablet such as those manufactured by Samsung, Inc. or Motorola, Inc., smart phone or PDA such as an iPhone-brand/iOS-based smart phone manufactured by Apple Inc., Android-based smart phone such as a Samsung Galaxy or HTC Droid smart phone, or any other type and form of computing device. FIG. 5 depicts a block diagram of a computing device 600 useful for practicing an embodiment of the client device 106, server 114, and producer device 128. A computing device 600 may include a central processing unit 601; a main memory unit 602; a visual display device 624; one or more input/output devices 630a-630b (generally referred to using reference numeral 630), such as a keyboard 626, which may be a virtual keyboard or a physical keyboard, and/or a pointing device 627, such as a mouse, touchpad, or capacitive or resistive single- or multi-touch input device; and a cache memory 640 in communication with the central processing unit 601.

The central processing unit 601 is any logic circuitry that responds to and processes instructions fetched from the main memory unit 602 and/or storage 628. The central processing unit may be provided by a microprocessor unit, such as: those manufactured by Intel Corporation of Santa Clara, Calif.; those manufactured by Motorola Corporation of Schaumburg, Ill.; those manufactured by Apple Inc. of Cupertino Calif., or any other single- or multi-core processor, or any other processor capable of operating as described herein, or a combination of two or more single- or multi-core processors. Main memory unit 602 may be one or more memory chips capable of storing data and allowing any storage location to be directly accessed by the microprocessor 601, such as random access memory (RAM) of any type. In some embodiments, main memory unit 602 may include cache memory or other types of memory.

The computing device 600 may support any suitable installation device 616, such as a floppy disk drive, a CD-ROM drive, a CD-R/RW drive, a DVD-ROM drive, tape drives of various formats, USB/Flash devices, a hard-drive or any other device suitable for installing software and programs such as any client agent 620, or portion thereof. The computing device 600 may further comprise a storage device 628, such as one or more hard disk drives or redundant arrays of independent disks, for storing an operating system and other related software, and for storing application software programs such as any program related to the client agent 620.

Furthermore, the computing device 600 may include a network interface 618 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, cellular connections, or some combination of any or all of the above. The network interface 618 may comprise a built-in network adapter, network interface card, PCMCIA network card, card bus network adapter, wireless network adapter, USB network adapter, cellular modem or any other device suitable for interfacing the computing device 600 to any type of network capable of communication and performing the operations described herein.

A wide variety of I/O devices 630a-630n may be present in the computing device 600. Input devices include keyboards, mice, trackpads, trackballs, microphones, drawing tablets, and single- or multi-touch screens. Output devices include video displays, speakers, headphones, inkjet printers, laser printers, and dye-sublimation printers. The I/O devices 630 may be controlled by an I/O controller 623 as shown in FIG. 5A. The I/O controller may control one or more I/O devices such as a keyboard 626 and a pointing device 627, e.g., a mouse, optical pen, or multi-touch screen. Furthermore, an I/O device may also provide storage 628 and/or an installation medium 616 for the computing device 600. The computing device 600 may provide USB connections to receive handheld USB storage devices such as the USB Flash Drive line of devices manufactured by Twintech Industry, Inc. of Los Alamitos, Calif.

The computing device 600 may comprise or be connected to multiple display devices 624a-624n, which each may be of the same or different type and/or form. As such, any of the I/O devices 630a-630n and/or the I/O controller 623 may comprise any type and/or form of suitable hardware, software embodied on a tangible medium, or combination of hardware and software to support, enable or provide for the connection and use of multiple display devices 624a-624n by the computing device 600. For example, the computing device 600 may include any type and/or form of video adapter, video card, driver, and/or library to interface, communicate, connect or otherwise use the display devices 624a-624n. A video adapter may comprise multiple connectors to interface to multiple display devices 624a-624n. The computing device 600 may include multiple video adapters, with each video adapter connected to one or more of the display devices 624a-624n. Any portion of the operating system of the computing device 600 may be configured for using multiple displays 624a-624n. Additionally, one or more of the display devices 624a-624n may be provided by one or more other computing devices, such as computing devices 600a and 600b connected to the computing device 600, for example, via a network. These embodiments may include any type of software embodied on a tangible medium designed and constructed to use another computer's display device as a second display device 624a for the computing device 600. One ordinarily skilled in the art will recognize and appreciate the various ways and embodiments that a computing device 600 may be configured to have multiple display devices 624a-624n.

A computing device 600 of the sort depicted in FIG. 5 typically operates under the control of an operating system, such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein.

The computing device 600 may have different processors, operating systems, and input devices consistent with the device. For example, in one embodiment, the computer 600 is an Apple iPhone or Motorola Droid smart phone, or an Apple iPad or Samsung Galaxy Tab tablet computer, incorporating multi-input touch screens. Moreover, the computing device 600 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software embodied on a tangible medium, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

What is claimed:

1. A method for providing audience interaction with a broadcast media program, comprising:
receiving, by a computing device from a producer of a broadcast media program, a request for audience input, the request comprising an audience question;
generating, by the computing device responsive to receiving the request, a question identifier;
transmitting, by the computing device to a plurality of remote computing devices, the question identifier;
receiving, by the computing device from a remote computing device of the plurality of remote computing devices, a media file recorded by a user of the remote computing device in response to the audience question, a user identifier, and the question identifier;
displaying, by the computing device to the producer, the audience question, an identifier of the received media file, and the corresponding user identifier; and
playing the received media file, by the computing device via an output device for broadcast, responsive to a playback selection by the producer.

2. The method of claim 1, wherein the media file is of a predetermined length.

3. The method of claim 1, wherein transmitting the question identifier further comprises transmitting, to the plurality of remote computing devices, the audience question.

4. The method of claim 1, wherein receiving the request comprising the audience question further comprises receiving, from the producer, a broadcast time of a topic corresponding to the audience question, and wherein transmitting the question identifier further comprises transmitting the question identifier to the plurality of remote computing devices, responsive to a current time matching the received broadcast time.

5. The method of claim 1, further comprising enabling the producer to select one of on air playback, storage, or deletion.

6. The method of claim 1, further comprising playing the received media file via an output device for preview, responsive to a preview selection by the producer.

7. The method of claim 1, further comprising:
receiving, by the computing device from a plurality of the remote computing devices, a corresponding plurality of media files and user identifiers;
displaying, by the computing device to the producer, the audience question, and a plurality of identifiers of the received media files and corresponding user identifiers; and
playing a selected subset of the plurality of the received media files in sequence, responsive to a preview selection by the producer of the subset.

8. The method of claim 1, further comprising:
generating a plurality of viewpoint identifiers, by the computing device, responsive to receiving the request;
transmitting, by the computing device to the plurality of remote computing devices, the plurality of viewpoint identifiers;
receiving, by the computing device from the remote computing device, the media file recorded by the user in response to the audience question, the user identifier, the question identifier, and one of the plurality of viewpoint identifiers selected by the user; and
displaying, by the computing device to the producer, the audience question, the identifier of the received media file, the corresponding user identifier, and the corresponding one of the plurality of viewpoint identifiers.

9. The method of claim 1, further comprising displaying, to the producer, an identifier of previously received media files associated with the received user identifier.

10. The method of claim 9, further comprising displaying, to the producer, an identifier of a subset of previously received media files associated with the received user identifier that were selected for playback by the producer.

11. A method for providing audience interaction with a broadcast media program, comprising:
receiving, by a computing device of a user from a remote computing device, a question identifier generated responsive to a request of a producer of a broadcast media program for audience input;
recording, by the computing device responsive to a user selection, a media file; and
transmitting, by the computing device to the remote computing device, the media file, the question identifier, and a user identifier;
wherein the audience question, user identifier, and an identifier of the media file are displayed by the remote computing device to the producer for selection and playback via an output device for broadcast.

12. The method of claim 11, wherein recording the media file comprises recording a media file of a predetermined length.

13. The method of claim 11, wherein receiving the question identifier further comprises receiving, from the remote computing device, an audience question.

14. The method of claim 13, further comprising displaying, by the computing device, the audience question to the user.

15. The method of claim 11, further comprising requesting, by the computing device, the user identifier from the user.

16. The method of claim 11, further comprising:
receiving, by the computing device from the remote computing device, a plurality of viewpoint identifiers;
displaying, by the computing device, the plurality of viewpoint identifiers to the user;
receiving, by the computing device, a selection of one of the plurality of viewpoint identifiers from the user; and
transmitting, by the computing device to the remote computing device, an identifier of the selected viewpoint.

17. A system for providing audience interaction with a broadcast media program, comprising:
a computing device comprising a processor configured for:
receiving, a producer of a broadcast media program, a request for audience input, the request comprising an audience question;
generating, responsive to receiving the request, a question identifier;
transmitting, to a plurality of remote computing devices, the question identifier;
receiving, from a remote computing device of the plurality of remote computing devices, a media file recorded by a user of the remote computing device in response to the audience question, a user identifier, and the question identifier;
displaying, to the producer, the audience question, an identifier of the received media file, and the corresponding user identifier; and
playing the received media file, via an output device for broadcast, responsive to a playback selection by the producer.

18. The system of claim 17, wherein the media file is of a predetermined length.

19. The system of claim 17, wherein the processor is further configured for:
receiving, from a plurality of the remote computing devices, a corresponding plurality of media files and user identifiers;
displaying, to the producer, the audience question, and a plurality of identifiers of the received media files and corresponding user identifiers; and
playing a selected subset of the plurality of the received media files in sequence, responsive to a preview selection by the producer of the subset.

20. The system of claim 17, wherein the processor is further configured for:
generating a plurality of viewpoint identifiers, responsive to receiving the request;
transmitting, to the plurality of remote computing devices, the plurality of viewpoint identifiers;
receiving, from the remote computing device, the media file recorded by the user in response to the audience question, the user identifier, the question identifier, and one of the plurality of viewpoint identifiers selected by the user; and
displaying, to the producer, the audience question, the identifier of the received media file, the corresponding user identifier, and the corresponding one of the plurality of viewpoint identifiers.
